(19) United States
(12) Patent Application Publication
(10) Pub. No.: US 2017/0076292 A1
(43) Pub. Date: Mar. 16, 2017

(54) ENHANCED FRAUD SCREENING PROCESS FOR FILTERING OF NETWORK STATISTICS IN ORDER TO DETECT, BLOCK, AND DETER FRAUDULENT ON-LINE ACTIVITY

(71) Applicant: BIS Global, Inc., Mclean, VA (US)

(72) Inventor: Philip Schmitz, Rockville, MD (US)

(21) Appl. No.: 15/255,706

(22) Filed: Sep. 2, 2016

Related U.S. Application Data
(60) Provisional application No. 62/218,044, filed on Sep. 14, 2015.

(51) Int. Cl. G06Q 20/40

(52) U.S. Cl. CPC G06Q 20/4016; G06Q 20/405

(57) ABSTRACT

Systems, methods, and computer readable media for screening a transaction for fraud prior to approval. The system comprises a central processing unit, a database coupled to the central processing unit, a plurality of data sources in communication with the central processing unit, and software executing on the central processing unit. Wherein the software parses the data from the plurality of data sources, compiles a list of trusted networks based on the parsed data, compares each transaction to the list of trusted networks, determines if each transaction is legitimate, illegitimate, or of questionable legitimacy based on the comparison and the transaction itself, approves the legitimate transactions, declines illegitimate transactions, and holds questionable transactions for further approval.

### REFERENCE TO RELATED APPLICATIONS

This application claims priority to U.S. Provisional Application No. 62/218,044, filed Sep. 14, 2015, entitled “ENHANCED FRAUD SCREENING PROCESS FOR FILTERING OF NETWORK STATISTICS IN ORDER TO DETECT, BLOCK, AND DETER FRAUDULENT ON-LINE ACTIVITY,” and is hereby specifically and entirely incorporated by reference.

### BACKGROUND OF THE INVENTION

1. Field of the Invention

This invention relates to the field of e-commerce, and more particularly to monitoring for fraudulent online activity.

2. Description of the Background

With the rise of e-commerce, there has been an increase in fraudulent activities within the Internet. Websites want to make the on-line purchasing of goods and services as easy and quick as possible for customers. Unfortunately, this process makes e-commerce sites a particularly ideal target for criminals who are attempting to test stolen credit card numbers (“phishing”). Companies who process fraudulent purchases get charge backs from the credit card associations when the real card holder disputes the charge. These charge backs usually cost the organization around $25-$40 per incident plus the time required to fill out paperwork.

There exist automated systems that recognize patterns and detect suspicious activity in near real-time and block malicious users from making fraudulent purchase. This system is effective for many cases. However, there are two gaps in this approach:
1) More sophisticated criminals that know how to leverage IP addresses swapping or spoofing or automated data manipulation are able to circumvent these systems to a certain degree leading to a higher rate of incidents before a pattern is detected;
2) Even the less sophisticated criminals are able to get a few incidents through prior to pattern detection, which can add up quickly for high-volume or larger organizations.

Even with complex pattern detection and automated blocking technology, this problem is significant and has real negative impact and cost implications for the e-commerce industry and will continue to get worse as more and more customers move to online shopping.

### SUMMARY OF THE INVENTION

The present invention overcomes the problems and disadvantages associated with current strategies and designs and provides new systems and methods of evaluating and preventing fraudulent charges. One embodiment of the invention is directed to a system of screening fraudulent online transactions prior to processing the transaction. The system comprises a central processing unit, a plurality of data sources in communication with the central processing unit, and software executing on the central processing unit. The software parses the data from the plurality of data sources, compiles a list of trusted networks based on the parsed data, collects online payment data for each transaction, compares each transaction to the list of trusted networks to determine if the transaction is originating from a trusted network, determines if each transaction is legitimate, illegitimate, or of questionable legitimacy based on the origin and the online payment data of each transaction, approves and processes the legitimate transactions, declines illegitimate transactions, and holds questionable transactions for further approval.

Preferably, the software further monitors each user's web activities prior to initiating the transaction. In a preferred embodiment, the software tracks at least one of each user's time spent on each page, the number of pages of the website each user views, from what source each user enters the website, the number of transactions each user makes, the number of payment types each user uses, and how often each user visits the website. Preferably, the software compares each user's web activities to the web activities of each other user to determine if a transaction is fraudulent. Preferably, the software further maintains a database of the questionable transactions and provides an interface for the questionable transactions to be approved or declined by a web administrator.

In a preferred embodiment the system further comprises at least one of a visual and audible alerting device to indicated to a web administrator that a transaction has at least one of been declined and that a questionable transaction is awaiting review. Preferably, the plurality of data sources includes environmental sources, infrastructure sources, and co-op data sources. Preferably, the online payment data includes at least one of IP address, networks data, geographical information, type of device, user name, user address, transaction amount, and email address. The software preferably further evaluates the online payment data to determine if the online payment data meets predefined criteria.

The system preferably further comprises at least one alerting device to indicate to at least one of a payment issuing service and a legal authority that a transaction has been declined. Preferably, comparing each transaction to the list of trusted networks to determine if the transaction is originating from a trusted network, comprises determining the ownership structure of the network, and determines if an unknown network is owned by the owner of a known network.

Another embodiment of the system is directed to a method of screening fraudulent online transactions prior to processing the transaction. The method comprises the steps of parsing the data from a plurality of data sources, compiling a list of trusted networks based on the parsed data, collecting online payment data for each transaction, comparing each transaction to the list of trusted networks to determine if the transaction is originating from a trusted network, determining if each transaction is legitimate, illegitimate, or of questionable legitimacy based on the origin and the online payment data of each transaction, approving and processing the legitimate transactions, declining illegitimate transactions, and holding questionable transactions for further approval.

Preferably, the method further comprises monitoring each user's web activities prior to initiating the transaction. In a preferred embodiment, the method further comprises tracking at least one of each user's time spent on each page, the number of pages of the website each user views, from what source each user enters the website, the number of transactions each user makes, the number of payment types each user uses, and how often each user visits the website. Preferably, the method further comprises comparing each user's web activities to the web activities of each other user to determine if a transaction is fraudulent. Preferably, the method further comprises maintaining a database of the questionable transactions and provides an interface for the questionable transactions to be approved or declined by a web administrator.

In a preferred embodiment, the method further comprises providing at least one of a visual and audible alerting device to indicated to a web administrator that a transaction has at least one of been declined and that a questionable transaction is awaiting review. Preferably, the plurality of data sources includes environmental sources, infrastructure sources, and co-op data sources. Preferably, the online payment data includes at least one of IP address, networks data, geographical information, type of device, user name, user address, transaction amount, and email address. Preferably, the method further comprises evaluating the online payment data to determine if the online payment data meets predefined criteria.

Preferably, the method further comprises providing at least one alerting device to indicate to at least one of a payment issuing service and a legal authority that a transaction has been declined. In a preferred embodiment, the step of comparing each transaction to the list of trusted networks to determine if the transaction is originating from a trusted network, comprises determining the ownership structure of the network, and determines if an unknown network is owned by the owner of a known network.

Other embodiments and advantages of the invention are set forth in part in the description, which follows, and in part, may be obvious from this description, or may be learned from the practice of the invention.

### BRIEF DESCRIPTION OF THE DRAWINGS

The invention is described in greater detail by way of example only and with reference to the attached drawings, in which:

FIG. 1 illustrates an example system embodiment.

FIG. 2 illustrates a schematic of the sources of data.

FIG. 3 illustrates an example of a screen shot of a potentially fraudulent transaction.

FIG. 4 illustrates another schematic of the sources of data

### DETAILED DESCRIPTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

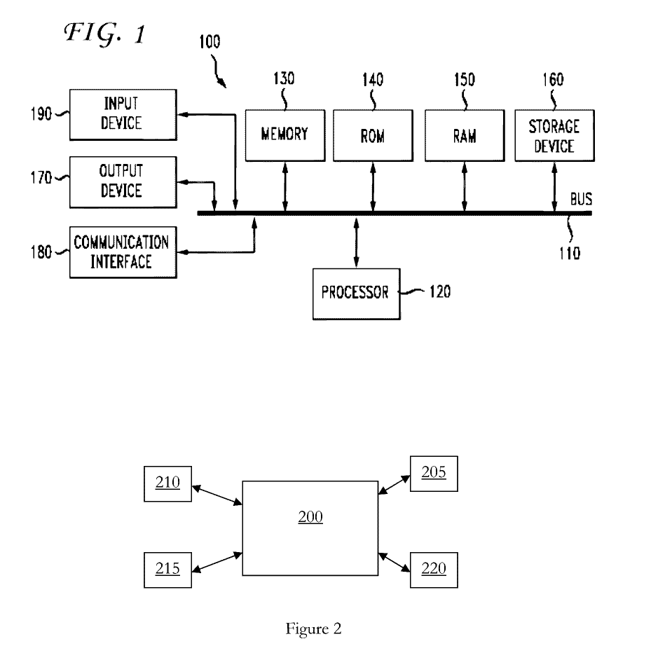

With reference to FIG. 1, an exemplary system includes at least one computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, a handheld scanning device, or a wireless devices, including wireless Personal Digital Assistants (“PDAs”) (e.g., Microsoft's Windows, Research in Motion's Blackberry™, an Android™ device, Apple's iPhone™), tablet devices (e.g., Amazon's Kindle™, Apple's iPad™), wireless web-enabled phones, other wireless phones, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed. For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a DSP circuit, may also be provided.

Embodiments within the scope of the present invention may also include computer-readable media (or software) for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium.

Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the preferred embodiment, the computer-readable media is hosted on a central computing device and delivered to remote computing devices via a network connection (as described herein). The computer-readable media is preferably a software as a service (SaaS) application with the remote computing devices accessing the SaaS via a web browser, downloaded application, or another interface. However, in other embodiments, at least a portion of the computing is completed on the remote computing devices.

In the preferred embodiment, a user utilizes an Internet connection in order to access a website on a host computer or to log into a mobile application. The different programs may be physically hosted together or separately. The web site may, for example, be maintained and hosted by a manufacturer, a supplier, or an Internet Service Provider. The website, when accessed, may request a user to log into the site by entering a username and password. Although, non-registered and non-logged in users may be able to browse the website. In the preferred embodiment, users will log in using a User Name and Password. However, in certain embodiments, additional information can be required, for example store number or company identification. The User Name and Password can be an email address or combination of letters, numbers, and/or symbols. Preferably, each User Name is unique. Based on user identification, access to the system can be determined. Furthermore, based on user identification, a user's preferences, accessible databases, and other resources the user has access to, is uploaded.

The system is preferably completely API (application programming interface) driven. Preferably, all access to the central processor, both internally and externally, is through the use of APIs. APIs can be opened to external web sites to enable creation of offers, redemption of offers, and other access to the central processor. Therefore, external systems can, if allowed by the system through valid authorization tokens, use some or all elements of the system to create new applications, enhancements or implementations without having to develop their own processes and systems which replicate functions and actions capable of being performed by the system.

The system is easily configurable for white labeling. As such, the system can be tailored to and/or branded for one or more specific purposes or companies and each such instance can run simultaneously. Each instance of the system may be branded for the third party and the third party could manage its own environment using the internal system controls (DERF/backend interface). Preferably in all such instances, each new instance's environment's subscribers and merchants would be segregated from the original instance (and all other instances) of the system.

The inventive system leverages real-time analytics network statistics that are collected from e-commerce statistics, coupled with publicly available data from ARIN (American Registry for Internet Numbers) and/or network data aggregators to tie the end user network location to a bigger network source (e.g. a Company, an Internet Service Provider, or an Individual) and then to combine those statistics with statistics from the current pattern detection process, along with overall web traffic patterns, malicious user incidents (e.g. web attacks), and assign a holistic, recently relevant score to indicate the trust of the network from where a customer is coming when they visit website. By leveraging this real-time trust indicator along with specific attributes of the actual intended transaction (e.g. recurring donation, tribute donation, peer-to-peer donation, country, etc.), the system can quarantine a customer's attempt to make a transaction if certain criteria are not met. This will prevent, for example, a criminal who is attempting to test a stolen credit card from knowing whether the card is good or bad, which will, in turn, deter them and also save the organization from a potential chargeback and the associated fees. The system will preferably significantly reduce the number of phishing attempts that can be initiated prior to pattern detection being triggered and can preemptively block users who are using more sophisticated tactics like IP address changing or spoofing.

FIG. 2 depicts a schematic of the sources parsed in order to create a trusted network determination. Central database 200 is preferably in data communication with multiple sources of information. For example, central database 200 may receive consumer transactional information from backend transaction processing software 205. Transaction processing software 205 may track and store information about each user that visits a website, including, but not limited to, IP address, name, billing address, shipping address, credit card information, banking information, demographic information, or other information about the user. The information may be collected directly from the user's computer (e.g. IP address) or may be entered by the user during check-out, sign-up, through donation forms, or another entry. Preferably, transaction processing software 205 monitors the user's activities while browsing a website. For example, transaction processing software 205 may track how much time a user spends on each page, how many pages of the website the user views, from what source the user enters the website, and how often the user visits the website. Preferably, central database 200 is able to collect data across multiple websites simultaneously.

Central database 200 may also obtain data from public records 210. For example, central database 200 is preferably adapted to parse ARIN records of an IP address to determine the owner, host, type of network, and additional information about the IP address. For example, central database 200 may be able to determine if the IP address is a person's personal computer accessing the Internet through a cable modem, or a company computer accessing the Internet through a dedicated direct line. Additionally, central database 200 may be able to determine what internet service provider a user is accessing the Internet through.

Additionally, central database 200 may review and compile data based on analytical software 215. The analytics may be proprietary, third party, or publicly available. Analytical software 215 may track trends, patterns, or other data across websites and over extended periods of time. For example, analytical software 215 may track decline to approval rates for users, from specific IP address, from specific networks, from specific geographical areas, from the types of devices accessing the websites, or other breakdowns. Additionally, analytical software 215 may track malicious attacks to determine from where and when attacks are likely to occur. Analytical software 215 may also maintain records of fraudulent activates discovered by the websites (e.g. past chargebacks for unauthorized charges). Analytical software 215 may also analyze patterns in real-time. For example, analytical software 215 may determine that one user has used multiple credit cards over a short period of time, possibly indicating that the user is trying to determine if stolen credit cards have been canceled (or phishing). As another example, analytical software 215 may be able to determine that a single user is accessing the internet from multiple IP addresses simultaneously, possibly indicating that the user is attempting to cloak their identity and location.

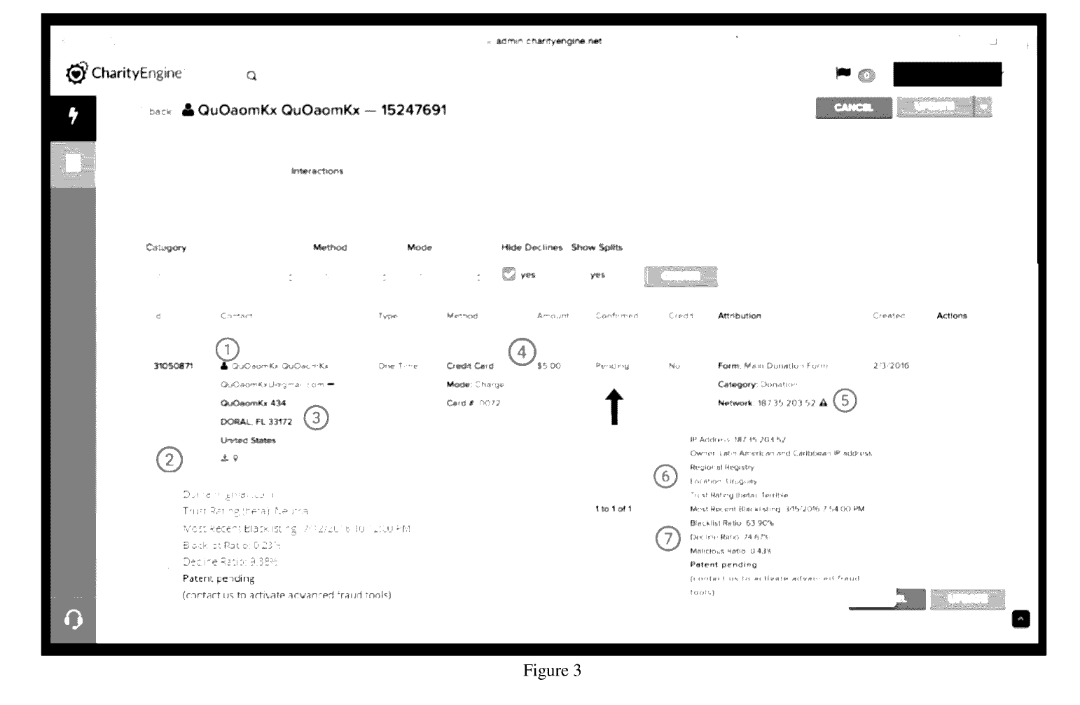

Central database 200 may also review a currently pending transaction 220. The currently pending transaction 220 may provide insight into whether the transaction is legitimate or fraudulent. For example, a transaction initiating a recurring purchase or donation may be considered to be legitimate even if coming from a network known to often have fraudulent purchases. As another example, if a known user is making a purchase with a known credit card the transaction may be considered to be legitimate even if coming from a network known to often have fraudulent purchases. FIG. 3 depict an example of a potentially fraudulent transaction. Data from the transaction itself that may indicate fraud may include; (1) an unusual name pattern (i.e. duplicate first & last names, inappropriate capitalization, numbers, punctuation, or other unusual characters); (2) common email domains (i.e. free and easy to obtain email addresses such as through Gmail, Yahoo, or MSN); (3) address does not follow standard formatting (i.e. duplicate words, inappropriate capitalization or numbers, punctuation, other unusual characters, zip codes that do not match the indicated city, or cities that do not match the state); (4) donations of $5 or less, such donations often indicate the user is testing the credit card; (5) flagged IP address or IP address does not match geographical location; (6) the user's location, certain geographical areas are more prone to fraud; and (7) the Blacklist Ratio and Decline Ratio for the users region. While no one factor is dispositive, each factor may lead to a decision that the transaction is fraudulent or may flag the transaction for further review. The system may have a set of rules or predefined criteria to compare to the transaction data to determine if the transaction contains problematic information that may indicate fraud.

Preferably, central database 200 compiles the data from all available sources and analyzes the data to create a network list of approved networks, questionable networks, and/or disapproved networks. While the term network is used the network list may include individual IP addresses, specific geographical areas, specific internet service providers, specific companies, or other entities. As more transactions occur and more data is available, the central database 200 continuously updates the list.

Each new transaction is compared to the network list prior to approval. If the transaction is originating from a trusted network, the transaction may be allowed to proceed. If the transaction is originating from a questionable network or a disapproved network, the system evaluates the transaction to determine if the transaction is legitimate. If the transaction is deemed to be legitimate it may be approved. If the transaction is deemed to be illegitimate it is preferably declined. If the system cannot determine if the transaction is legitimate, the transaction is preferably held pending further approval, alerting the user that the transaction cannot be processed currently. The system preferably maintains a list of held transactions for each website being monitored. A website administrator can approve or decline each questionable transaction to complete the transaction. The system may send an alert to the website administrator of any pending and/or declined transactions. The alert may be audible, visual, an email, a text message, and/or by another mode of communication. Additionally, the system may send an alert to authorities and/or the credit card issuer of any declined transactions. The alert may be audible, visual, an email, a letter, a text message, and/or by another mode of communication.

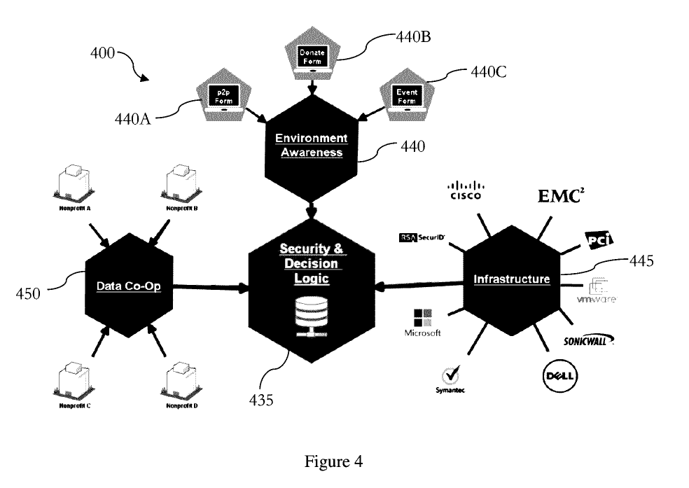

FIG. 4 depicts another schematic of a system 400 for environment-based filtering of transactions. The central processing unit 435 takes information from the environment 440, co-op data 450, and system infrastructure 445. The environmental factors 440 may include, for example, the transactional data from peer-to-peer donations 440A, traditional donations 440B, and event registrations 440C. The transaction is evaluated based on real-time data received from multiple web-facing endpoints to determine where, when, and for what reason the transaction is taking place. Unlike traditional security systems that are independent of the systems they protect, system 400 is directly connected to each website so that system 400 can inspect and understand what online users are doing at a more intimate level. System 400 performs accurate analysis of user behaviors and makes decisions about what behavior is unlikely to be a real donor depending upon the environment. For example, on an organizations run/walk event website, system 400 may be aware that a normal user behavior is to donate on multiple different pages in a short period of time because in those types of sites, users are encouraged to search for their friends and donate on their pages. Alternatively, this behavior is uncommon on a donation form where users click and typically donate once or twice.

Co-op data 450 is preferably shared knowledge from a plurality of anonymized, aggregated data points across all of system 400's clients. For example, data collected from each non-profit entity, each for-profit entity, and any other clients of system 400 is analyzed and stored in a database accessible by any of system 400's other clients. As the number of data points recorded increases the accuracy in determining the legitimacy of transactions preferably increases. In addition to the data itself, the data is manipulated to aid in identifying networks of trust (or mistrust). The preferred goal is the ability to connect a source network that has not previously been seen within seconds, to the co-op even if there is no co-op history available for the network. This is preferably achieved through a process where system 400, in near real-time, connects to publicly available data on the Internet's IP address ranges and ownership structure (which is a hierarchical structure—e.g. Level 3 may lease large blocks of IP spaces from ARIN and then sub-lease them to local providers, who then may sign a contract to further sublease them to, for example, Starbucks in the DC metro area, who then uses them at hundreds of retail locations to provide free Wi-Fi). System 400 preferably traverses these ownership structures and then immediately connects a new location (e.g. new Starbucks shop) to the rest of the network and hierarchy to imply trust (or mistrust). The reason this is so effective is because, while no system, can have all of the data needed to make the best decision for every network, this association to other networks where data is available is almost as effective because companies and providers have trends based on how strict or lax they are or based on what types of customers or users they have. Similar attention is preferably paid to email addresses. For example, Yahoo and Gmail implied trust is similar to the network implied trust. However, the email service provider association is a simple match on data, whereas the network association preferably requires complex data enrichment processes to understand the connections because an IP address does not tell you implicitly that the provider is good or bad.

System 400 additionally preferably incorporates information received from various infrastructure sources 445. System 400 preferably incorporates feedback from events occurring within a variety of hardware devices, including, but not limited to firewalls, IP detection, and geo-based IP blocking systems. Preferably, system 400 inputs data from standard security devices and feeds them into the data warehouse to factor into the algorithm that assigns trust to an Internet network. Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising” includes the terms “consisting of” and “consisting essentially of,” and the terms comprising, including, and containing are not intended to be limiting.

1. A system of screening fraudulent online transactions prior to processing the transaction, comprising:
a central processing unit;
a plurality of data sources in communication with the central processing unit;
software executing on the central processing unit, wherein the software:
parses the data from the plurality of data sources;
compiles a list of trusted networks based on the parsed data;
collects online payment data for each transaction;
compares each transaction to the list of trusted networks to determine if the transaction is originating from a trusted network;
determines if each transaction is legitimate, illegitimate, or of questionable legitimacy based on the origin and the online payment data of each transaction;
approves and processes the legitimate transactions;
declines illegitimate transactions; and
holds questionable transactions for further approval.

2. The system of claim 1, wherein the software further monitors each user's web activities prior to initiating the transaction.

3. The system of claim 2, wherein the software tracks at least one of each user's time spent on each page, the number of pages of the website each user views, from what source each user enters the website, the number of transactions each user makes, the number of payment types each user uses, and how often each user visits the website.

4. The system of claim 2, wherein the software compares each user's web activities to the web activities of each other user to determine if a transaction is fraudulent.

5. The system of claim 1, wherein the software further maintains a database of the questionable transactions and provides an interface for the questionable transactions to be approved or declined by a web administrator.

6. The system of claim 1, further comprising at least one of a visual and audible alerting device to indicated to a web administrator that a transaction has at least one of been declined and that a questionable transaction is awaiting review.

7. The system of claim 1, wherein the plurality of data sources includes environmental sources, infrastructure sources, and co-op data sources.

8. The system of claim 1, wherein the online payment data includes at least one of IP address, networks data, geographical information, type of device, user name, user address, transaction amount, and email address.

9. The system of claim 8, wherein the software further evaluates the online payment data to determine if the online payment data meets predefined criteria.

10. The system of claim 1, further comprising at least one alerting device to indicate to at least one of a payment issuing service and a legal authority that a transaction has been declined.

11. The system of claim 1, wherein comparing each transaction to the list of trusted networks to determine if the transaction is originating from a trusted network, comprises determining the ownership structure of the network, and determines if an unknown network is owned by the owner of a known network.

12. A method of screening fraudulent online transactions prior to processing the transaction, comprising the steps of:
parsing the data from a plurality of data sources;
compiling a list of trusted networks based on the parsed data;
collecting online payment data for each transaction;
comparing each transaction to the list of trusted networks to determine if the transaction is originating from a trusted network;
determining if each transaction is legitimate, illegitimate, or of questionable legitimacy based on the origin and the online payment data of each transaction;
approving and processing the legitimate transactions;
declining illegitimate transactions; and
holding questionable transactions for further approval.

13. The method of claim 12, further comprising monitoring each user's web activities prior to initiating the transaction.

14. The method of claim 13, further comprising tracking at least one of each user's time spent on each page, the number of pages of the website each user views, from what source each user enters the website, the number of transactions each user makes, the number of payment types each user uses, and how often each user visits the website.

15. The method of claim 13, further comprising comparing each user's web activities to the web activities of each other user to determine if a transaction is fraudulent.

16. The method of claim 12, further comprising maintaining a database of the questionable transactions and provides an interface for the questionable transactions to be approved or declined by a web administrator.

17. The method of claim 12, further comprising providing at least one of a visual and audible alerting device to indicated to a web administrator that a transaction has at least one of been declined and that a questionable transaction is awaiting review.

18. The method of claim 12, wherein the plurality of data sources includes environmental sources, infrastructure sources, and co-op data sources.

19. The method of claim 12, wherein the online payment data includes at least one of IP address, networks data, geographical information, type of device, user name, user address, transaction amount, and email address.

20. The method of claim 19, further comprising evaluating the online payment data to determine if the online payment data meets predefined criteria.

21. The method of claim 12, further comprising providing at least one alerting device to indicate to at least one of a payment issuing service and a legal authority that a transaction has been declined.

22. The method of claim 12, wherein the step of comparing each transaction to the list of trusted networks to determine if the transaction is originating from a trusted network, comprises determining the ownership structure of the network, and determines if an unknown network is owned by the owner of a known network.
